(19) United States
(12) Patent Application Publication
(10) Pub. No.: US 2026/0104775 A1
(43) Pub. Date: Apr. 16, 2026

(54) TOUCH PANEL, DISPLAY DEVICE, AND METHOD OF CONTROLLING TOUCH PANEL

(71) Applicant: Sharp Display Technology Corporation, Kameyama City (JP)

(72) Inventor: Takeshi KAMEDA, Kameyama City (JP)

(21) Appl. No.: 19/353,870

(22) Filed: Oct. 9, 2025

(30) Foreign Application Priority Data
Oct. 15, 2024 (JP) 2024-179639

(51) Int. Cl. G06F 3/044; G06F 3/041

(52) U.S. Cl. CPC G06F 3/0443; G06F 3/0412

(57) ABSTRACT

A touch panel includes a touch detection control circuit. The touch detection control circuit determines the presence or absence of a filter, and, upon determining that the filter is not provided, amplifies a signal from a touch sensor at a first amplification factor to generate a first amplified signal, and, based on the first amplified signal, determines whether or not there is a touch on the touch sensor with a pointing object. Upon determining that the filter is provided, the touch detection control circuit amplifies a signal from the touch sensor at a second amplification factor, which is greater than the first amplification factor, to generate a second amplified signal, and, based on the second amplified signal, determines whether or not there is a touch on the touch sensor with the pointing object.

### BACKGROUND

### 1. Field

The present disclosure relates to a touch panel, a display device, and a method of controlling a touch panel.

### 2. Description of the Related Art

A protective film detection method described in the specification of U.S. Pat. No. 10,739,913 is a method of acquiring a signal change level of a touch screen and determining that a protective film is attached to the touch screen if a difference between the signal change level of the touch screen and a signal change level of a reference touch screen is not greater than a preset threshold.

In a case where a protective film (a filter) is attached to a touch screen (a touch panel), the protective film is disposed between a pointing object and a touch sensor; therefore, there is a greater distance between the pointing object and the touch sensor. In this case, the level of a signal obtained from the touch sensor decreases, resulting in a decrease in sensitivity of touch detection by the touch panel.

The present disclosure provides a touch panel, a display device, and a method of controlling a touch panel that makes it possible to perform touch detection using a touch sensor with appropriate sensitivity, irrespective of the presence or absence of a filter.

### SUMMARY

A touch panel according to a first aspect includes a touch sensor configured to form an electrostatic capacitance with a pointing object, and a control circuit. Based on a signal from the touch sensor, the control circuit determines whether or not a filter is provided between the touch sensor and the pointing object. Upon determining that the filter is not provided between the touch sensor and the pointing object, the control circuit amplifies a signal from the touch sensor at a first amplification factor to generate a first amplified signal, and, based on the first amplified signal, determines whether or not there is a touch on the touch sensor with the pointing object. Upon determining that the filter is provided between the touch sensor and the pointing object, the control circuit amplifies a signal from the touch sensor at a second amplification factor, which is greater than the first amplification factor, to generate a second amplified signal, and, based on the second amplified signal, determines whether or not there is a touch on the touch sensor with the pointing object.

A display device according to a second aspect includes the touch panel according to the first aspect, and a display layered on the touch panel.

A method of controlling a touch panel according to a third aspect is a method of controlling a touch panel that includes a touch sensor configured to form an electrostatic capacitance with a pointing object. The method includes determining, based on a signal from the touch sensor, whether or not a filter is provided between the touch sensor and the pointing object. The method includes, upon determining that the filter is not provided between the touch sensor and the pointing object, amplifying a signal from the touch sensor at a first amplification factor to generate a first amplified signal, and, based on the first amplified signal, determining whether or not there is a touch on the touch sensor with the pointing object. The method includes, upon determining that the filter is provided between the touch sensor and the pointing object, amplifying a signal from the touch sensor at a second amplification factor, which is greater than the first amplification factor, to generate a second amplified signal, and, based on the second amplified signal, determining whether or not there is a touch on the touch sensor with the pointing object.

### BRIEF DESCRIPTION OF THE DRAWINGS

FIG. 1 is a perspective view schematically illustrating a configuration of an information terminal according to a first embodiment;

FIG. 2 is a perspective view schematically illustrating a configuration of the information terminal according to the first embodiment;

FIG. 3 is a cross-sectional view schematically illustrating a configuration of the information terminal according to the first embodiment;

FIG. 4 is a cross-sectional view schematically illustrating a configuration of the information terminal according to the first embodiment;

FIG. 5 is a block diagram for explaining a configuration of each component of the information terminal according to the first embodiment;

FIG. 6 is a diagram schematically illustrating a configuration of an active matrix board;

FIG. 7 is a diagram for explaining an amplified signal in a case where a filter is provided on a touch panel and an amplified signal in a case where the filter is not provided on the touch panel;

FIG. 8 is a flowchart for explaining processing for determining an amplification factor by the information terminal according to the first embodiment;

FIG. 9 is a flowchart for explaining processing for detecting a touch position by the information terminal according to the first embodiment;

FIG. 10 is a block diagram illustrating a configuration of an information terminal according to a second embodiment;

FIG. 11 is a flowchart for explaining an operation of the information terminal according to the second embodiment;

FIG. 12 is a block diagram illustrating a configuration of an information terminal according to a third embodiment;

FIG. 13 is a diagram illustrating an example of display on a touch panel by a display control circuit according to the third embodiment;

FIG. 14 is a diagram for explaining a calibration mode according to the third embodiment;

FIG. 15 is a diagram for explaining the calibration mode according to the third embodiment; and

FIG. 16 is a flowchart for explaining an operation of a touch panel according to a variation example of the first to third embodiments.

### DESCRIPTION OF THE EMBODIMENTS

Based on the drawings, embodiments of the present disclosure will be described below. The present disclosure shall not be construed to be limited to the embodiments described below. A design variation may be applied as appropriate, provided that the applied variation satisfies a configuration disclosed herein. In the following description, the same reference signs will be used in common throughout different drawings for the same portions and portions having similar functions, and the same description of them will not be repeated. The configurations described in the embodiments and the variation examples may be combined and/or changed as appropriate, provided that the combination/change is not a deviation from the spirit of the present disclosure. For easier understanding, in the drawings referred to in the following description, the configurations will sometimes be illustrated in a simplified/schematic manner, and a part of components will sometimes be omitted.

### First Embodiment

### Overall Configuration of Information Terminal 100

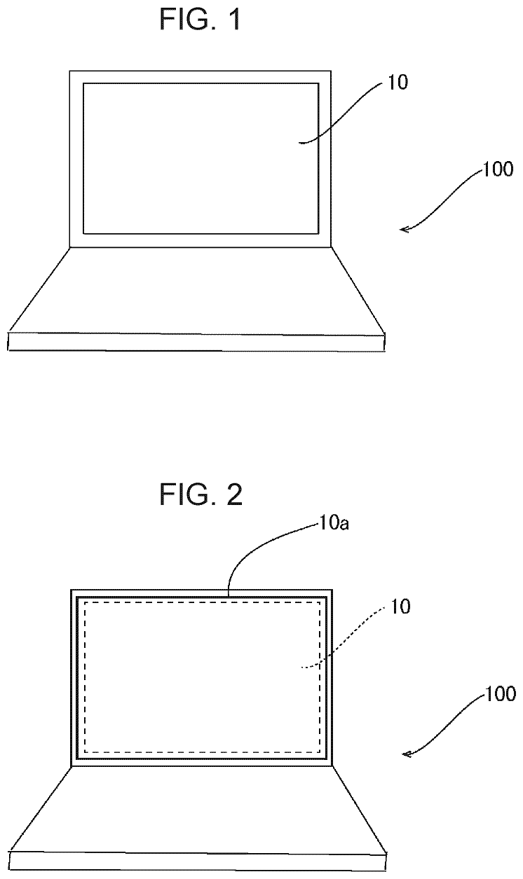

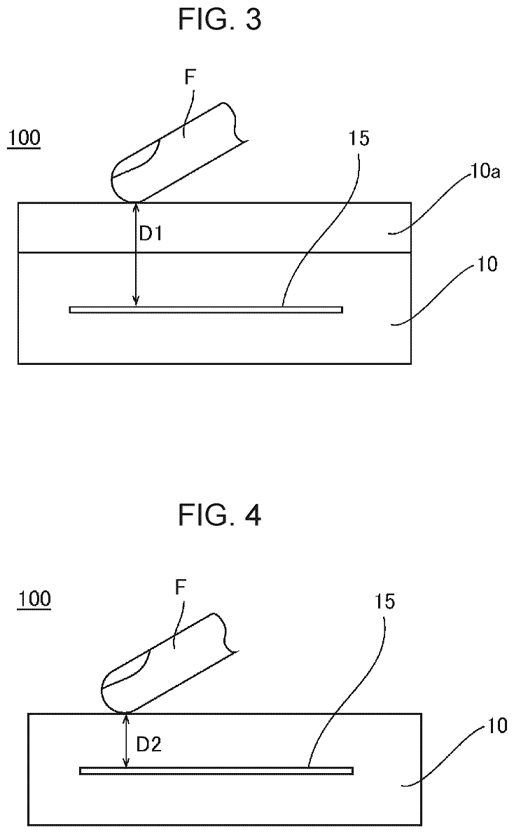

Each of FIGS. 1 and 2 is a perspective view schematically illustrating a configuration of an information terminal 100 according to a first embodiment. Each of FIGS. 3 and 4 is a cross-sectional view schematically illustrating a configuration of the information terminal 100 according to the first embodiment. The information terminal 100 according to the first embodiment is, for example, a personal computer, a tablet terminal, a smartphone, a smartwatch, etc. As illustrated in FIG. 1, the information terminal 100 includes a touch panel 10. As illustrated in FIG. 2, the information terminal 100 includes a filter 10a. As illustrated in FIG. 3, the filter 10a is overlaid on the touch panel 10. The filter 10a, for example, a privacy filter, limits an angle at which light coming from the touch panel 10 is allowed to pass through the filter 10a. The filter 10a is detachably attached to the touch panel 10.

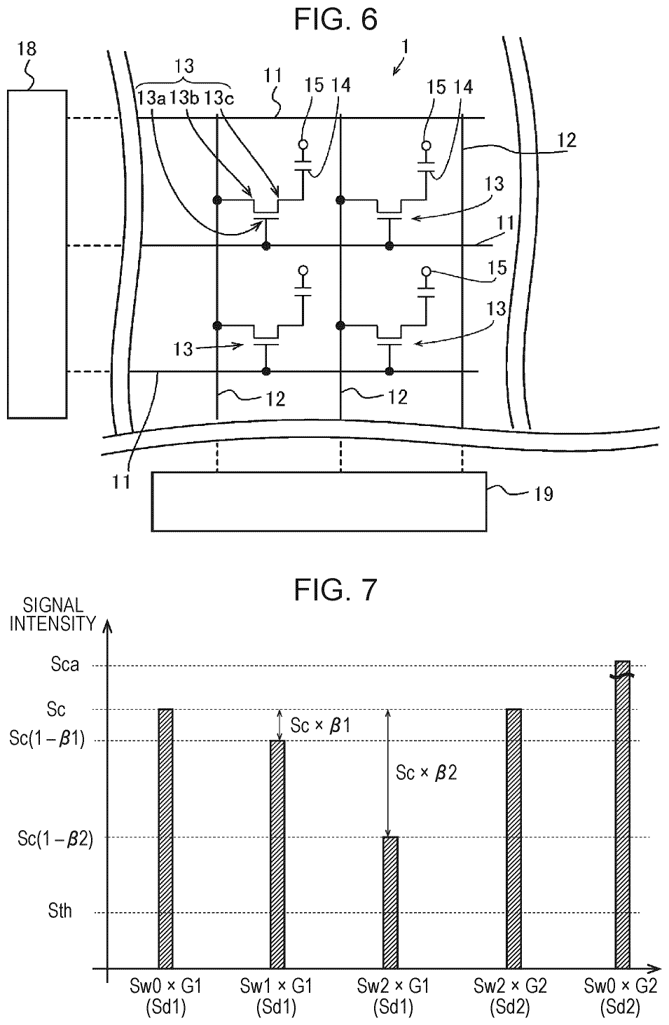

The touch panel 10 has a function of detecting a touch with a pointing object F (see FIG. 3) and a function as a display configured to display an image. The touch panel 10 is, for example, an in-cell touch panel. The touch panel 10 includes a touch sensor 15. The touch sensor 15 behaves as an electrode (common electrode) in the display, and drives liquid crystal inside the touch panel 10 by generating an electric field between the touch sensor 15 and a pixel electrode 14 (see FIG. 6) facing the touch sensor 15. That is, in the touch panel 10, the display is provided in an integrally layered manner.

Let D1 be a distance between the touch sensor 15 and the pointing object F in a state illustrated in FIG. 3, in which the filter 10a is provided on the touch panel 10. Let D2 be a distance between the touch sensor 15 and the pointing object F in a state illustrated in FIG. 4, in which the filter 10a is not provided on the touch panel 10. The distance D1 is greater than the distance D2. Therefore, an electrostatic capacitance between the touch sensor 15 and the pointing object F in the state in which the filter 10a is provided on the touch panel 10 is smaller than in the state in which the filter 10a is not provided thereon. Therefore, a signal level from the touch sensor 15 is lower. In view of this relation, in the touch panel 10 according to the first embodiment, it is determined whether or not the filter 10a is provided between the touch sensor 15 and the pointing object F. Then, in a case where it is determined that the filter 10a is not provided between the touch sensor 15 and the pointing object F, the touch panel 10 amplifies the signal from the touch sensor 15 at an amplification factor G1 to generate an amplified signal Sd1, and, based on the amplified signal Sd1, determines whether or not there is a touch on the touch sensor 15 with the pointing object F. In a case where it is determined that the filter 10a is provided between the touch sensor 15 and the pointing object F, the touch panel 10 amplifies the signal from the touch sensor 15 at an amplification factor G2, which is greater than the amplification factor G1, to generate an amplified signal Sd2, and, based on the amplified signal Sd2, determines whether or not there is a touch on the touch sensor 15 with the pointing object F.

According to this configuration, whether there is a touch or not is determined based on the amplified signal Sd2, which is obtained by amplifying the signal from the touch sensor 15 at the amplification factor G2, in the case where the filter 10a is provided between the touch sensor 15 and the pointing object F; therefore, touch detection sensitivity improves even when the filter 10a is provided on the touch panel 10. In the case where the filter 10a is not provided between the touch sensor 15 and the pointing object F, the amplified signal Sd1 subjected to amplification at the amplification factor G1 is generated; therefore, the amplified signal Sd1 will not be excessive in level (no signal value saturation occurs). This enables touch detection using the touch sensor 15 with appropriate sensitivity, regardless of whether or not the filter 10a is provided.

### Configuration of Each Component of Information Terminal 100

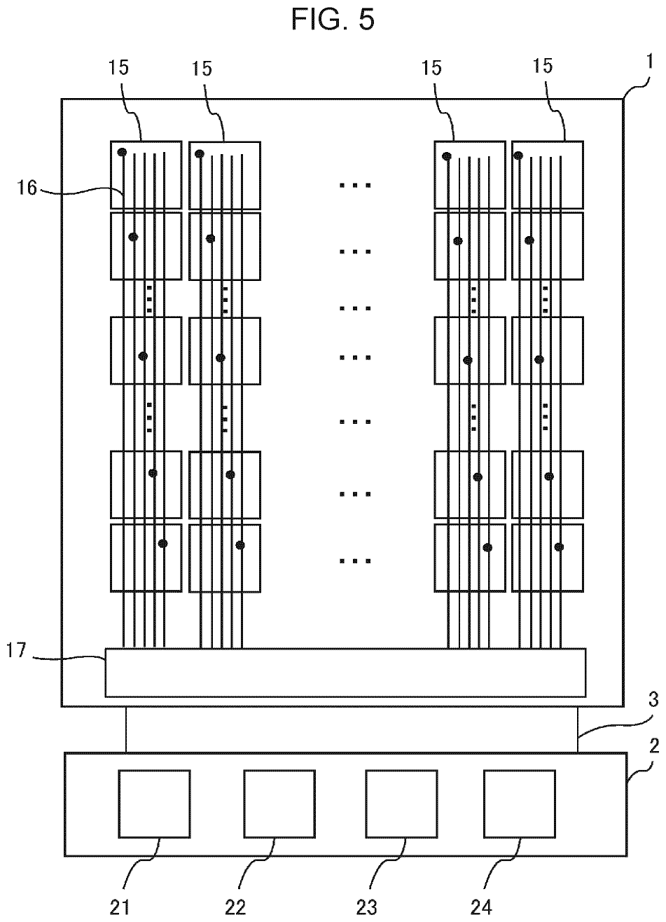

FIG. 5 is a block diagram for explaining a configuration of each component of the information terminal 100 according to the first embodiment. The information terminal 100 includes an active matrix board 1, a control board 2, and a flexible printed board 3, which connects the active matrix board 1 and the control board 2 to each other. Plural touch sensors 15 are arranged on the active matrix board 1. The plural touch sensors 15 are arranged in, for example, rows and columns. A circuit 17 is provided on the active matrix board 1. The circuit 17 is connected to each of the plurality of touch sensors 15 via wiring 16.

The control board 2 includes a timing control circuit 21, a touch detection control circuit 22, a backlight driving circuit 23, and a power supply circuit 24. The timing control circuit 21 is a circuit configured to control the operation timings of the touch detection control circuit 22, a gate driving circuit 18, and a source driving circuit 19. The timing control circuit 21 transmits control signals, to the touch detection control circuit 22, the gate driving circuit 18, and the source driving circuit 19, for time division between a period during which control processing for touch detection is performed and a period during which processing for display is performed. The electrostatic capacitance of the touch sensor 15 changes due to capacitive coupling with the pointing object. The touch detection control circuit 22 supplies a touch driving signal (pulse signal) to the plurality of touch sensors 15 during the period during which the processing for touch detection is performed. The waveform of the pulse signal varies according to the magnitude of the electrostatic capacitance of the touch sensor 15. The circuit 17, an analog front end, converts the signal from the touch sensor 15 (analog signal) into a digital signal, and performs denoising using a noise-cut filter. Then, the circuit 17 transmits the denoised signal to the touch detection control circuit 22. The touch detection control circuit 22 acquires a difference value (hereinafter referred to as “detection signal”) between the denoised signal and a pre-stored non-touch-state signal, and amplifies the detection signal to acquire an amplified signal.

During at least a part of a period within one cycle of a vertical synchronization signal, the backlight driving circuit 23 supplies power to a non-illustrated backlight provided inside the touch panel 10 to turn the backlight ON. The power supply circuit 24 supplies, to each component inside the touch panel 10, power supplied from a non-illustrated battery.

FIG. 6 is a diagram schematically illustrating a configuration of the active matrix board 1. As illustrated in FIG. 6, a plurality of gate lines 11, which is connected to the gate driving circuit 18, and a plurality of source lines 12, which is connected to the source driving circuit 19, are arranged on the active matrix board 1. The plurality of gate lines 11 and the plurality of source lines 12 are arranged in an intersecting manner. A pixel is provided at each of areas compartmentalized by the plurality of gate lines 11 and the plurality of source lines 12. The plural pixels are arranged in a matrix layout in the active matrix board 1.

A transistor 13 and a pixel electrode 14 are provided at each pixel. The gate electrode 13a of the transistor 13 is connected to the gate line 11. The source electrode 13b of the transistor 13 is connected to the source line 12. The drain electrode 13c of the transistor 13 is connected to the pixel electrode 14.

When the transistor 13 is turned ON by a driving signal (gate signal) supplied from the gate driving circuit 18 via the gate line 11, a source signal supplied from the source driving circuit 19 via the source line 12 is written into the pixel electrode 14 (charged). This produces an electric field between the pixel electrode 14 and the touch sensor 15. Driven by the electric field produced between the pixel electrode 14 and the touch sensor 15, the non-illustrated liquid crystal allows light coming from the backlight to pass through itself and thus displays an image on the touch panel 10. That is, the touch sensor 15 doubles as the displaying electrode (common electrode). The touch panel 10 is a self-capacitance-type touch panel. This is, however, a non-limiting example. The touch panel 10 may be configured as a mutual-capacitance-type touch panel.

### Operation of Information Terminal 100 According to First Embodiment

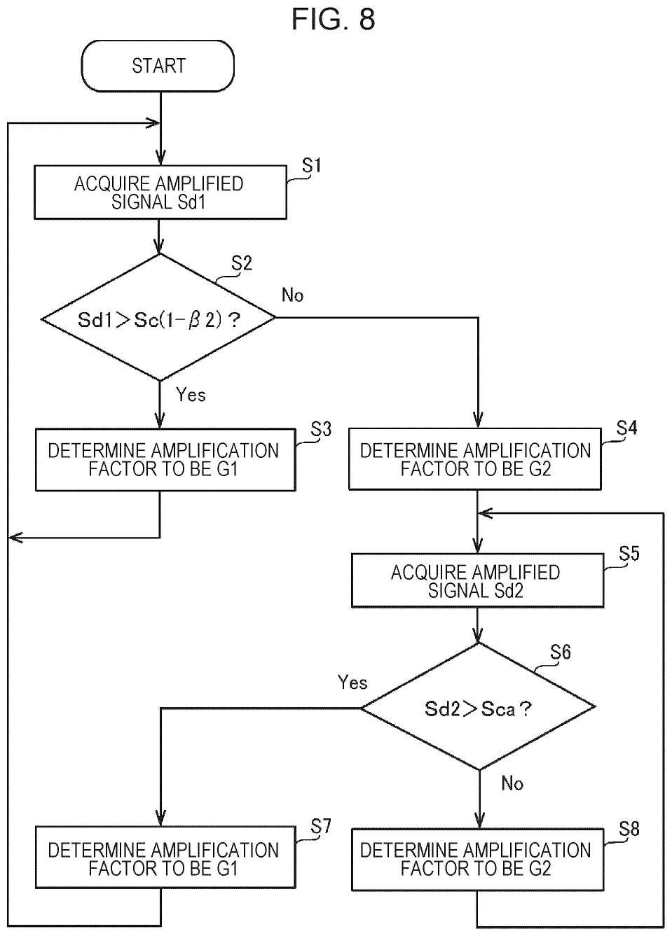

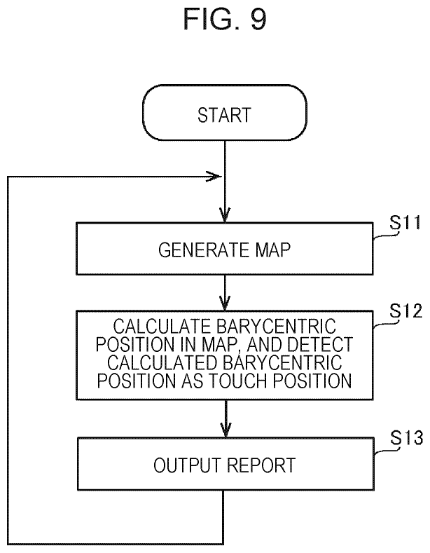

With reference to FIGS. 7 to 9, an operation of the information terminal 100 according to the first embodiment will now be described. FIG. 7 is a diagram for explaining an amplified signal in a case where the filter 10a is provided on the touch panel 10 and an amplified signal in a case where the filter 10a is not provided on the touch panel 10. FIG. 8 is a flowchart for explaining processing for determining an amplification factor by the information terminal 100 according to the first embodiment. FIG. 9 is a flowchart for explaining processing for detecting a touch position by the information terminal 100 according to the first embodiment. In the first embodiment, the processing for determining the amplification factor illustrated in FIG. 8 is performed by the touch detection control circuit 22.

Let Sw0 be a detection signal obtained when the touch panel 10 is touched with the pointing object F in a case where the filter 10a is not provided on the touch panel 10. Let Sc (=Sw0×G1) be the level of an amplified signal obtained by amplifying the detection signal Sw0 at the amplification factor G1. This level of the amplified signal is hereinafter referred to as “reference value Sc”. As illustrated in FIG. 7, the reference value Sc is a value that is greater than a threshold Sth for determining the presence of a touch. If the level of a signal (amplified signal) from the touch sensor 15 that is the one closest to the pointing object F among the plurality of touch sensors 15 is not less than the reference value Sc, not only the value of the signal (amplified signal) from this touch sensor 15, meaning the closest one, but also the values of signals (amplified signals) from a plurality of touch sensors 15 located near this touch sensor 15, fall within a dynamic range. The dynamic range is, for example, a range from 5 inclusive to 320 inclusive when quantized in 9 bit (0 to 511). Therefore, it is possible to detect the position of the touch with the pointing object F (hereinafter referred to as “touch position”) with high precision by calculating the barycentric position of the signals (amplified signals) from the plurality of touch sensors 15 (barycenter calculation). The reference value Sc is a value within the dynamic range.

There are various types of the filter 10a, and the user can use the filter 10a of the user's arbitrary choice. A case where a first filter 10a is provided on the touch panel 10 and a case where a second filter 10a is provided on the touch panel 10 will be described below. Let Sw1 be a detection signal obtained when the touch panel 10 is touched with the pointing object F in a case where the first filter 10a is provided on the touch panel 10. Let Sw2 be a detection signal obtained when the touch panel 10 is touched with the pointing object F in a case where the second filter 10a is provided on the touch panel 10. The first filter 10a is thinner than the second filter 10a. The level of a signal obtained by amplifying the detection signal Sw1 at the amplification factor G1 (meaning Sw1×G1) is Sc×(1−β1) (, where 0<β1<1). The level of a signal obtained by amplifying the detection signal Sw2 at the amplification factor G1 (meaning Sw2×G1) is Sc×(1−β2) (, where 0<β2<1, and β1<β2).

In the case where the first filter 10a is provided on the touch panel 10, not only the value of the signal (amplified signal) from the touch sensor 15 that is the one closest to the pointing object F among the plurality of touch sensors 15 but also the values of signals (amplified signals) from a plurality of touch sensors 15 located near this touch sensor 15 fall within the dynamic range; therefore, there is no need to increase the amplification factor from G1. On the other hand, at the amplified signal level of Sc×(1−β2) or lower in the case where the second filter 10a is provided on the touch panel 10, although the value of the signal (amplified signal) from the touch sensor 15 that is the one closest to the pointing object F exceeds the threshold Sth, the values of the signals (amplified signals) from the other neighboring touch sensors 15 are unable to exceed the threshold Sth; therefore, there is a possibility of falling outside the dynamic range. For this reason, at the amplified signal level of Sc×(1−β2) or lower, the precision of the calculated touch position is low.

### Processing for Determining Amplification Factor

In view of the above, in the first embodiment, as illustrated in FIG. 8, the touch panel 10 performs processing for determining an amplification factor. In step S1, the amplified signal Sd1 subjected to amplification of the detection signal at the amplification factor G1 is acquired. Then, in step S2, it is determined whether or not the amplified signal Sd1 is greater in level than Sc×(1−β2). That is, based on the amplified signal Sd1, it is determined whether or not the filter 10a for which there is a need to increase the amplification factor (for example, the second filter 10a) is provided on the touch panel 10. Among the signals (amplified signal Sd1) from the plurality of touch sensors 15, the amplified signals Sd1 the level of which is not less than the threshold Sth are compared with Sc×(1−β2). The process proceeds, from step S2, to step S3 in a case where the amplified signal Sd1 is greater than Sc×(1−β2), or to step S4 in a case where the amplified signal Sd1 is not greater than Sc×(1−β2). In the first embodiment, the process proceeds to step S4 if the amplified signal Sd1 is determined to be not greater than Sc×(1−β2) more than once consecutively. For example, if the amplified signal Sd1 is determined to be not greater than Sc×(1−β2) throughout a plurality of (for example, ten) frame periods consecutively, the process proceeds to step S4. This makes it possible to suppress erroneous determination in a case where the amplified signal Sd1 is not greater than Sc×(1−β2) just once due to noise or the like.

In step S3, the amplification factor is determined to be G1, and the process returns to step S1. That is, it is determined that the filter 10a (filter for which there is a need to increase the amplification factor) is not provided between the touch sensor 15 and the pointing object F. In this case, based on the amplified signal Sd1 subjected to amplification at the amplification factor G1, it is determined whether or not there is a touch on the touch sensor 15 with the pointing object F (see FIG. 9).

In step S4, the amplification factor is determined to be G2, and the process proceeds to step S5. That is, it is determined that the filter 10a (filter for which there is a need to increase the amplification factor) is provided between the touch sensor 15 and the pointing object F. In this case, based on the amplified signal Sd2 subjected to amplification at the amplification factor G2, it is determined whether or not there is a touch on the touch sensor 15 with the pointing object F (see FIG. 9).

In step S5, the amplified signal Sd2 subjected to amplification of the detection signal at the amplification factor G2 is acquired. If the filter 10a is removed from the touch panel 10, the level of the detection signal rises to Sw0; therefore, if the detection signal Sw0 is amplified at the amplification factor G2, as illustrated in FIG. 7, the amplified signal Sd2 becomes far greater in level than the reference value Sc, and thus it could happen that the level of the amplified signal Sd2 reaches the upper limit of a detectable range (signal value saturation could occur). This could make it difficult to calculate an accurate position in touch position calculation (when calculating the barycenter).

In view of the above, in the first embodiment, in step S6, it is determined whether or not the amplified signal Sd2 is greater in level than Sca. Among the signals (amplified signal Sd2) from the plurality of touch sensors 15, the amplified signals Sd2 the level of which is not less than the threshold Sth are compared with Sca. The value of Sca is greater than the reference value Sc; for example, Sca is a value that is beyond an appropriate dynamic range (for example, in a case of 9 bit, 511 or so). In a case where the amplified signal Sd2 is greater in level than Sca, the process proceeds to step S7 to set the amplification factor back to G1. That is, in the case where the amplified signal Sd2 is greater in level than Sca, it is determined that the filter 10a has been removed, and the amplification factor is set back to G1. This suppresses a situation where the level of the amplified signal Sd2 reaches the upper limit of the detectable range (suppresses signal value saturation) and makes it possible to calculate the touch position accurately (makes it possible to calculate the barycenter accurately). After step S7, the process returns to step S1. In the first embodiment, the process proceeds to step S7 to set the amplification factor back to G1 if the amplified signal Sd2 is determined to be greater than Sca more than once consecutively (for example, throughout ten frame periods consecutively). This makes it possible to suppress erroneous determination in a case where the amplified signal Sd2 is greater than Sca just once due to noise or the like.

In a case where the amplified signal Sd2 is not greater in level than Sca, the process proceeds to step S8, and the state of the amplification factor G2 is maintained. After that, the process returns to step S5.

### Processing for Calculating Touch Position

As illustrated in FIG. 9, in step S11, the amplified signal Sd1 is acquired if the amplification factor determined in the processing for determining the amplification factor is G1, or the amplified signal Sd2 is acquired if the amplification factor determined in the processing for determining the amplification factor is G2. Then, a map in which the coordinates of each of the plurality of touch sensors 15 are associated with the amplified signal Sd1 of each of the plurality of touch sensors 15 is generated. Then, in step S12, the barycentric position in the map is calculated (barycenter calculation), and the calculated barycentric position is detected as the touch position. In step S13, a report that includes the detected touch position is transmitted to a non-illustrated host controller (control circuit provided on the information terminal 100 side). After that, the process returns to step S11.

According to the first embodiment, in a case where the filter 10a is provided between the touch sensor 15 and the pointing object F, whether there is a touch or not is determined based on the amplified signal Sd2, which is obtained by amplifying the detection signal at the amplification factor G2 that is greater than the amplification factor G1; therefore, even in a case where the filter 10a is provided on the touch panel 10, it is possible to improve touch detection sensitivity. In a case where the filter 10a is not provided between the touch sensor 15 and the pointing object F, the amplified signal Sd1 subjected to amplification at the amplification factor G1 is generated; therefore, the amplified signal Sd1 will not be excessive in level (no signal value saturation occurs). This enables touch detection by the touch panel 10 with appropriate sensitivity, regardless of whether or not the filter 10a is provided.

An alternative configuration that is conceivable is to lower the threshold Sth in the case where the filter 10a is provided between the touch sensor 15 and the pointing object F. However, even if the threshold Sth is lowered, if the values of signals (amplified signals) from, among the plurality of touch sensors 15, a plurality of touch sensors 15 located near the touch sensor 15 that is the one closest to the pointing object F are outside the dynamic range, the number of the signals from the touch sensors 15 that can be used for barycenter calculation becomes smaller; therefore, precision in detecting the touch position decreases. By contrast, according to the first embodiment, since the amplification factor is increased from G1 to G2 in the case where the filter 10a is provided between the touch sensor 15 and the pointing object F, the values of the signals (amplified signals) from the plurality of neighboring touch sensors 15 also fall within the dynamic range. This makes it possible to make the precision in detecting the touch position higher than in the configuration of lowering the threshold Sth.

### Second Embodiment

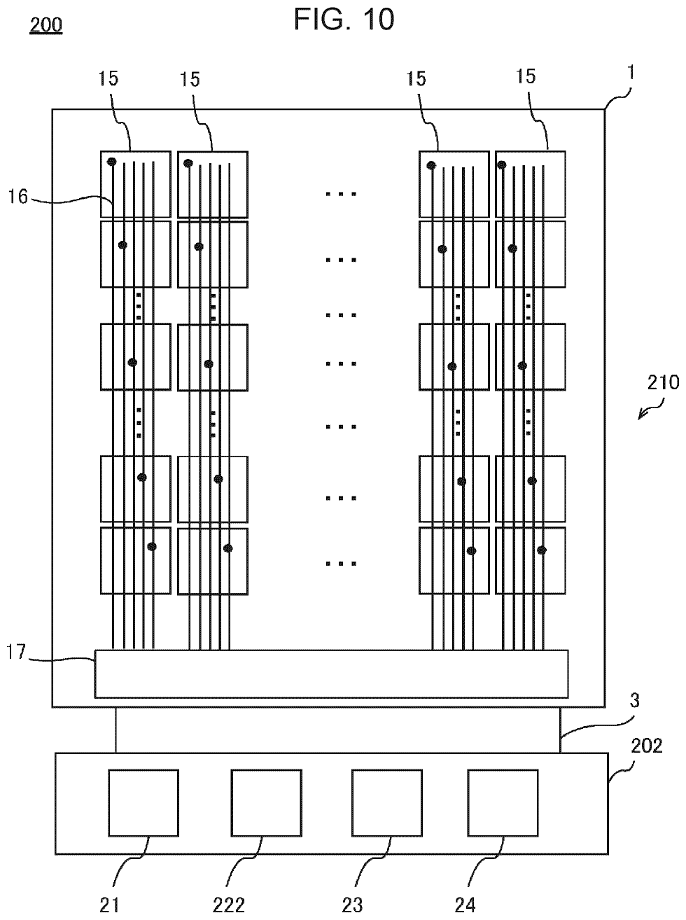

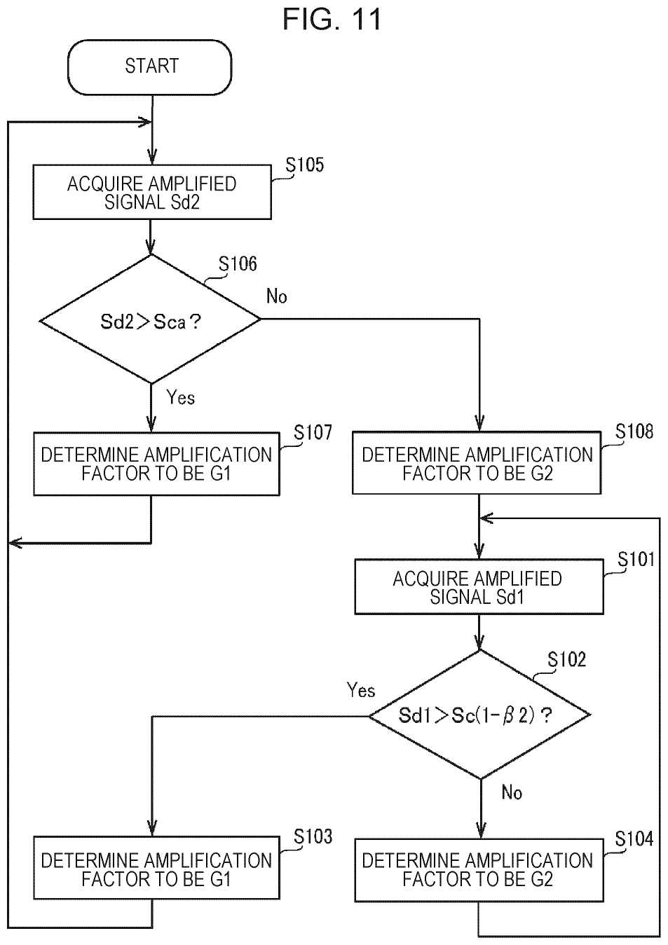

Next, with reference to FIGS. 10 and 11, a configuration of an information terminal 200 according to a second embodiment will now be described. In the second embodiment, the filter 10a (see FIG. 2) is provided as standard in the information terminal 200, and the user can remove the filter 10a. The same reference signs as those of the first embodiment will be used for components that are the same as those of the first embodiment, and description thereof will be omitted.

FIG. 10 is a block diagram illustrating the configuration of the information terminal 200 according to the second embodiment. As illustrated in FIG. 10, the information terminal 200 according to the second embodiment includes a touch panel 210. The touch panel 210 includes a control board 202, which includes a touch detection control circuit 222.

FIG. 11 is a flowchart for explaining an operation of the information terminal 200 according to the second embodiment. The operation of the information terminal 200 (control processing) is performed by the touch detection control circuit 222. In the information terminal 200, first, in step S105, the amplified signal Sd2 is acquired. The operation in steps S105 to S108 is the same as the operation in steps S5 to S8; therefore, it is not explained here. After step S108, step S101 is executed. The operation in steps S101 to S104 is the same as the operation in steps S1 to S4; therefore, it is not explained here. According to the second embodiment, even when the filter 10a is provided as standard between the touch sensor 15 and the pointing object F, it is possible to detect the removal of the filter 10a; therefore, it is possible to perform touch detection using the touch sensor 15 with appropriate sensitivity. The other configuration and effects of the second embodiment are similar to the configuration and effects of the first embodiment.

### Third Embodiment

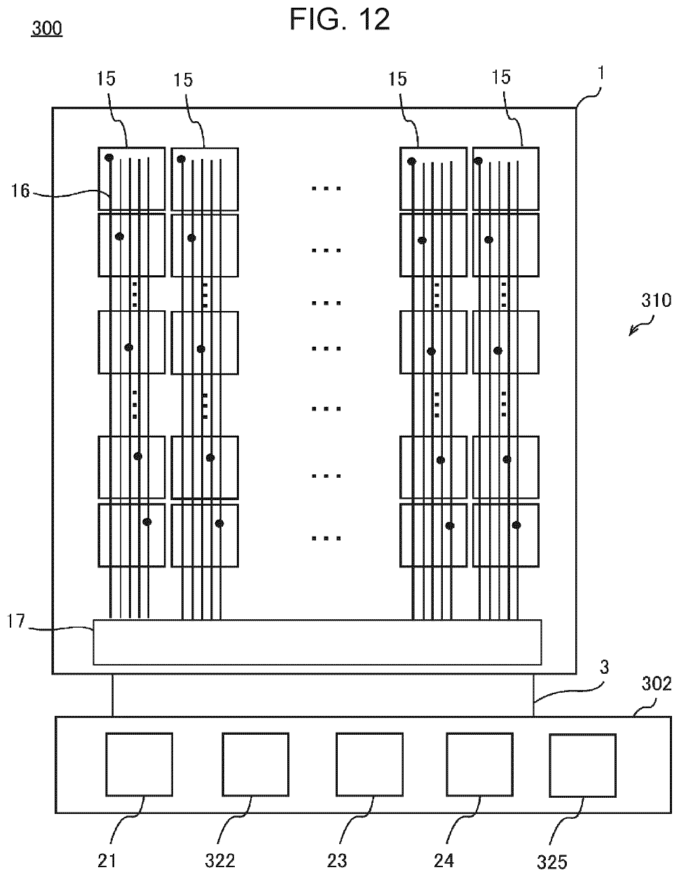

Next, with reference to FIGS. 12 to 15, a configuration of an information terminal 300 according to a third embodiment will now be described. In the third embodiment, the information terminal 300 is configured to initiate a calibration mode in response to a user operation, and, based on a signal (amplified signal) acquired from the touch sensor 15 during the execution of the calibration mode, calibrate the amplification factor. The same reference signs as those of the first embodiment will be used for components that are the same as those of the first embodiment, and description thereof will be omitted.

FIG. 12 is a block diagram illustrating the configuration of the information terminal 300 according to the third embodiment. As illustrated in FIG. 12, the information terminal 300 according to the third embodiment includes a touch panel 310. The touch panel 310 includes a control board 302, which includes a touch detection control circuit 322 and a display control circuit 325.

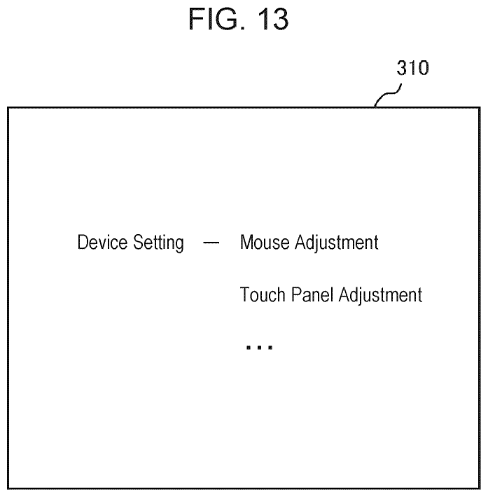

FIG. 13 is a diagram illustrating an example of display on the touch panel 310 by the display control circuit 325 according to the third embodiment. The display control circuit 325 causes the touch panel 310 to display a setting screen. Through an input operation on the setting screen, the user can configure settings of each device (including the touch panel 310) mounted in the information terminal 300. The display control circuit 325 initiates the calibration mode in response an operation performed by the user on an “Adjust Touch Panel” image (button). The calibration mode means a state of executing processing for calibrating the amplification factor.

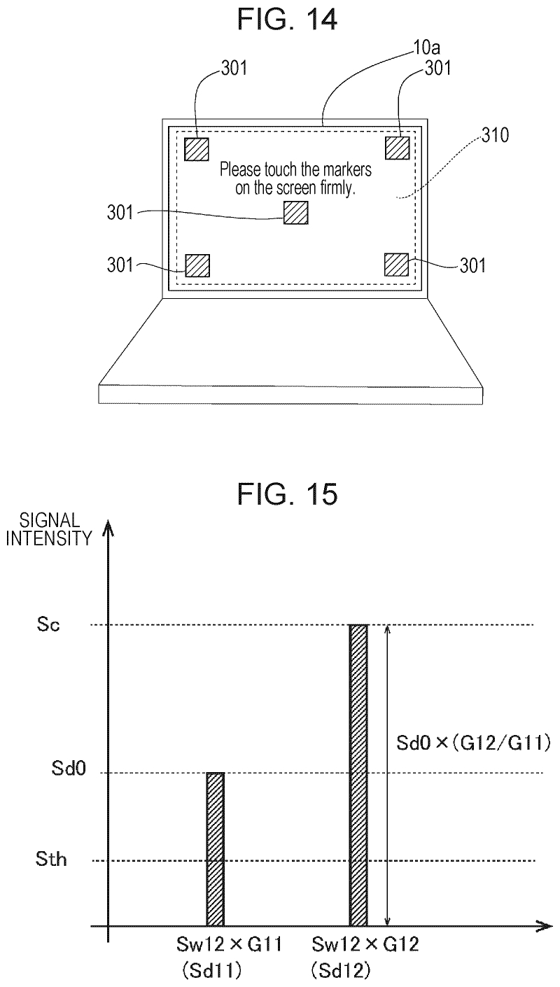

Each of FIGS. 14 and 15 is a diagram for explaining the calibration mode according to the third embodiment. As illustrated in FIG. 14, in the calibration mode, the display control circuit 325 commands that a plurality of markers 301 be displayed at a plurality of positions on the touch panel 310 together with a message (saying, for example, “Please touch the markers on the screen firmly.”). The plurality of markers 301 is displayed such that they are spaced from one another on the touch panel 310. Each of the plurality of markers 301 has the same dimensions as the dimensions of one touch sensor 15. That is, the vertical size and the horizontal size of the marker 301 in a plan view are the same as those of the touch sensor 15. Each of the plurality of markers 301 is displayed at a position where it is in alignment with any one of the plurality of touch sensors 15 in a plan view. That is, the marker 301 is displayed without positional offset from the touch sensor 15. This makes a signal from the one of the touch sensors 15 dominant among the detection signals; therefore, it becomes easier to compare signal intensities and calibrate the amplification factor. For example, the plural markers 301 are displayed near the four corners of the touch panel 310 and at the center of the touch panel 310.

As illustrated in FIG. 15, the touch detection control circuit 322 acquires an amplified signal Sd11 by amplifying, at an amplification factor G11, a detection signal Sw12 from the touch sensor 15 corresponding to the coordinates of each marker 301, and calculates an average value Sd0 of the amplified signals Sd11 from all of the plurality of markers 301. Then, the touch detection control circuit 322 determines an amplification factor G12 that brings the average value Sd0 to the reference value Sc. That is, the touch detection control circuit 322 determines the amplification factor G12 that makes the following equation holds true: the amplification factor G12=(the reference value Sc/the detection signal Sw12). Therefore, in the third embodiment, in a case where it is determined that the filter 10a is provided between the touch sensor 15 and the pointing object F, the greater the value of the difference between the average value Sd0 and the reference value Sc is, the greater value the touch detection control circuit 322 sets the amplification factor G12 to. Then, based on an amplified signal Sd12 subjected to amplification of the detection signal Sw12 at the amplification factor G12, the touch detection control circuit 322 detects the touch position. Even when the type of the filter 10a is changed, this makes it possible to calibrate the amplification factor G11 to the amplification factor G12 and thus makes it possible to perform the touch detection with appropriate sensitivity. Moreover, since the calibration of the amplification factor is performed based on signals from the touch sensors 15 of the plurality of positions, it is possible to calibrate the amplification factor to a value that reflects various touch states. The other configuration and effects of the third embodiment are similar to the configuration and effects of the first embodiment.

### Variation Examples

Though some embodiments of the present disclosure have been described above, the above embodiments are just examples for implementation of the present disclosure. Therefore, the above embodiments may be implemented in a modified manner as appropriate within a scope of not departing from the spirit of them. Some variation examples of the above embodiments will be described below.

(1) In the first to third embodiments described above, a touch panel (and a display device) is provided in an information terminal. However, the scope of the present disclosure is not limited to this example. The touch panel may be provided in a display device different from the information terminal. The touch panel may be without a display function.

(2) In the first to third embodiments described above, the filter is configured as a privacy filter. However, the scope of the present disclosure is not limited to this example. For example, the filter may be configured as a protective filter that guards the touch panel from scratches, or as a spectral filter that blocks some specific wavelengths of light, such as a blue light reduction filter.

(3) In the first to third embodiments described above, G1 or G2 that is equal to the amplification factor used for touch detection is employed as the amplification factor for determining the presence or absence of the filter (step S2, S6, S102, S106). However, the scope of the present disclosure is not limited to this example. The amplification factor used for determining the presence or absence of the filter (step S2, S6, S102, S106) may be set to any value other than G1 or G2.

(4) In the third embodiment described above, in the calibration mode, the markers are displayed at a plurality of positions on the touch panel. However, the scope of the present disclosure is not limited to this example. For example, a single mark only may be displayed on the touch panel.

(5) In the first to third embodiments described above, the touch detection control circuit executes the processing for determining the presence or absence of the filter and the processing for determining the amplification factor. However, the scope of the present disclosure is not limited to this example. For example, a control circuit other than the touch detection control circuit (for example, a host controller, or a calibration-only circuit provided discretely from the touch detection control circuit) may execute this processing.

(6) In the first to third embodiments described above, the amplified signal is compared with a predetermined value more than once, and, based on the results of the comparison, the presence or absence of the filter is determined (the amplification factor is determined). However, the scope of the present disclosure is not limited to this example. For example, the amplified signal may be compared with a predetermined value just once, and, based on the result of the comparison, the presence or absence of the filter may be determined (the amplification factor may be determined).

(7) In the first to third embodiments described above, the touch panel is configured as an in-cell touch panel. However, the scope of the present disclosure is not limited to this example. For example, the touch panel may be configured as an on-cell touch panel or an out-cell touch panel.

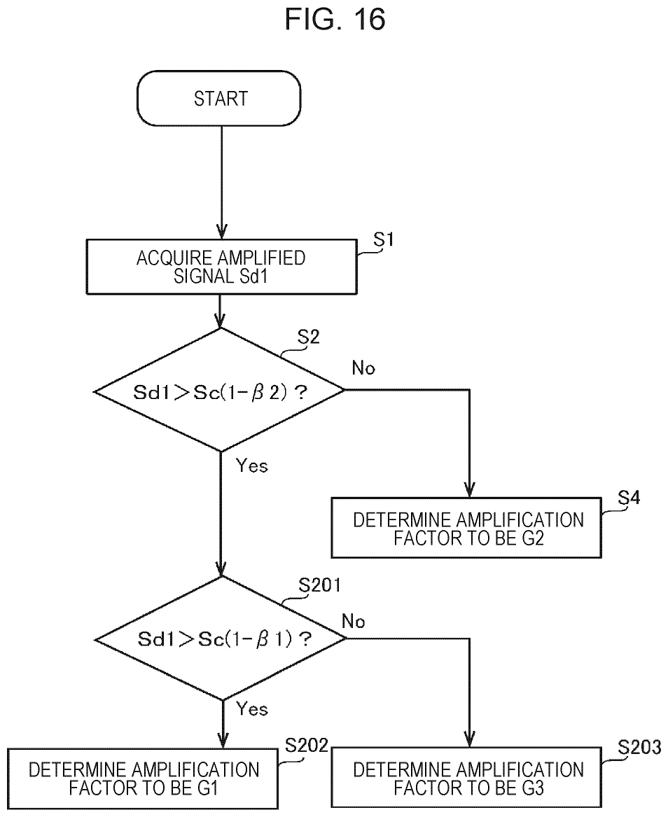

(8) In the first embodiment described above, the amplified signal Sd1 is compared with a single threshold only, specifically, with Sc×(1−β2). However, the scope of the present disclosure is not limited to this example. That is, the amplified signal Sd1 may be compared with a plurality of thresholds, and, based on the results of the comparison, the amplification factor may be determined. For example, as in a touch panel according to a variation example illustrated in FIG. 16, in a case where the amplified signal Sd1 is greater in level than Sc (1−β2) in step S2, the amplified signal Sd1 may be compared with Sc (1−β1) in step S201, and the amplification factor may be set to G1 in step S202 if the amplified signal Sd1 is greater in level than Sc (1−β1), or the amplification factor may be set to G3, which is greater than G1 and less than G2, in step S203 if the amplified signal Sd1 is not greater in level than Sc (1−β1).

The foregoing configurations may be described as follows.

A touch panel according to a first configuration includes: a touch sensor configured to form an electrostatic capacitance with a pointing object; and a control circuit, wherein the control circuit is configured to, based on a signal from the touch sensor, determine whether or not a filter is provided between the touch sensor and the pointing object, upon determining that the filter is not provided between the touch sensor and the pointing object, amplify a signal from the touch sensor at a first amplification factor to generate a first amplified signal, and, based on the first amplified signal, determine whether or not there is a touch on the touch sensor with the pointing object, and, upon determining that the filter is provided between the touch sensor and the pointing object, amplify a signal from the touch sensor at a second amplification factor to generate a second amplified signal, the second amplification factor being greater than the first amplification factor, and, based on the second amplified signal, determine whether or not there is a touch on the touch sensor with the pointing object (first configuration).

According to the first configuration, whether there is a touch or not is determined based on the second amplified signal, which is obtained by amplifying the signal from the touch sensor at the second amplification factor, which is greater than the first amplification factor, in a case where the filter is provided between the touch sensor and the pointing object; therefore, touch detection sensitivity improves even when the filter is provided on the touch panel. In a case where the filter is not provided between the touch sensor and the pointing object, the first amplified signal subjected to amplification at the first amplification factor is generated; therefore, the first amplified signal will not be excessive in level (no signal value saturation occurs). This enables touch detection using the touch sensor with appropriate sensitivity, regardless of whether or not the filter is provided.

An alternative configuration that is conceivable is to lower the threshold for touch detection in the case where the filter is provided between the touch sensor and the pointing object. However, even if the threshold is lowered, if the values of signals (amplified signals) from, among the plurality of touch sensors, a plurality of touch sensors located near the touch sensor that is the one closest to the pointing object are outside the dynamic range, the number of the signals from the touch sensors that can be used for barycenter calculation becomes smaller; therefore, precision in detecting the touch position decreases. By contrast, according to the first configuration, since the amplification factor is increased in the case where the filter is provided between the touch sensor and the pointing object, the values of the signals (amplified signals) from the plurality of neighboring touch sensors also fall within the dynamic range. This makes it possible to make the precision in detecting the touch position higher than in the configuration of lowering the threshold.

In the first configuration, the control circuit may be configured to, amplify a signal from the touch sensor at a third amplification factor to generate a third amplified signal, determine that the filter is provided between the touch sensor and the pointing object when the third amplified signal is not less than a first threshold but not greater than a second threshold, the first threshold being a threshold for touch detection, the second threshold being greater than the first threshold, and determine that the filter is not provided between the touch sensor and the pointing object when the third amplified signal is greater than the second threshold (second configuration).

In the case where the filter is provided between the touch sensor and the pointing object, the signal from the touch sensor has a level that enables touch detection (not less than the first threshold) but is not great enough (not greater than the second threshold). In this case, since the signal from the touch sensor does not have a sufficient level, the precision of the touch position calculated through barycenter calculation based on a plurality of positions is low. By contrast, according to the second configuration described above, it is determined that the filter is provided between the touch sensor and the pointing object when the signal from the touch sensor (third amplified signal) is not greater than the second threshold even when it is not less than the first threshold, which is the threshold for touch detection. Therefore, it is possible to suppress a decrease in the precision of the calculated touch position.

In either one of the first and second configurations, the control circuit may be configured to determine that the filter is provided between the touch sensor and the pointing object when the third amplified signal that is not less than the first threshold but not greater than the second threshold is acquired consecutively a predetermined plurality of number of times, and determine that the filter is not provided between the touch sensor and the pointing object when the third amplified signal that is not less than the first threshold but not greater than the second threshold is not acquired consecutively the predetermined plurality of number of times (third configuration).

According to the third configuration described above, it is possible to suppress erroneous determination in a case where the third amplified signal is not less than the first threshold but not greater than the second threshold just once due to noise or the like.

In any one of the first to third configurations, the control circuit may be configured to, upon determining that the filter is provided between the touch sensor and the pointing object, determine the second amplification factor such that, the greater a value of a difference between a signal from the touch sensor and a reference value is, the greater a determined value of the second amplification factor is (fourth configuration).

According to the fourth configuration described above, it is possible to determine the second amplification factor according to an amount of change in the signal from the touch sensor with respect to the reference value (an amount of decrease). Consequently, it is possible to determine the second amplification factor to be an appropriate value.

In the second or third configuration, the control circuit may be configured to, when the second amplified signal has become greater than a third threshold after determining that the filter is provided between the touch sensor and the pointing object, the third threshold being greater than the second threshold, determine that the filter provided between the touch sensor and the pointing object has been removed (fifth configuration).

According to the fifth configuration described above, it is possible to detect the absence of the filter even in a case where the filter provided between the touch sensor and the pointing object has been removed.

In any one of the first to fifth configurations, the control circuit may be configured to amplify a signal from the touch sensor at a fourth amplification factor to generate a fourth amplified signal, the fourth amplification factor being greater than the first amplification factor, determine that the filter has been removed when the fourth amplified signal has become greater than a fourth threshold, and determine that the filter is provided when the fourth amplified signal is not greater than the fourth threshold (sixth configuration).

According to the sixth configuration described above, even when the filter is provided as standard between the touch sensor and the pointing object, it is possible to detect the removal of the filter; therefore, it is possible to perform touch detection using the touch sensor with appropriate sensitivity.

In any one of the first to sixth configurations, the control circuit may be configured to initiate a calibration mode in response to a user operation, and, based on a signal acquired from the touch sensor during an execution of the calibration mode, calibrate the second amplification factor (seventh configuration).

According to the seventh configuration described above, even when the type of the filter is changed, it is possible to calibrate the amplification factor; therefore, it possible to perform the touch detection using the touch sensor with appropriate sensitivity.

In the seventh configuration, the control circuit may be configured to, based on a signal, from the touch sensor, outputted when each of a plurality of positions spaced from one another on the touch sensor is touched with the pointing object during the execution of the calibration mode, calibrate the second amplification factor (eighth configuration).

A state (angle and contact area) of a touch with the pointing object varies depending on a touch position. In this respect, according to the eighth configuration described above, since the second amplification factor is calibrated based on signals from the touch sensor(s) of the plurality of positions, it is possible to calibrate the second amplification factor to a value that reflects various touch states.

A display device according to a ninth configuration includes the touch panel according to any one of the first to eighth configurations and a display layered on the touch panel (ninth configuration).

The ninth configuration described above makes it possible to provide a display device capable of performing touch detection using the touch sensor with appropriate sensitivity, regardless of whether or not the filter is provided.

A method of controlling a touch panel according to a tenth configuration is a method of controlling a touch panel that includes a touch sensor configured to form an electrostatic capacitance with a pointing object. The method includes determining, based on a signal from the touch sensor, whether or not a filter is provided between the touch sensor and the pointing object. The method includes, upon determining that the filter is not provided between the touch sensor and the pointing object, amplifying a signal from the touch sensor at a first amplification factor to generate a first amplified signal, and, based on the first amplified signal, determining whether or not there is a touch on the touch sensor with the pointing object.

The method includes, upon determining that the filter is provided between the touch sensor and the pointing object, amplifying a signal from the touch sensor at a second amplification factor, which is greater than the first amplification factor, to generate a second amplified signal, and, based on the second amplified signal, determining whether or not there is a touch on the touch sensor with the pointing object (tenth configuration).

The tenth configuration described above makes it possible to provide a method of controlling a touch panel capable of performing touch detection using the touch sensor with appropriate sensitivity, regardless of whether or not the filter is provided.

The present disclosure contains subject matter related to that disclosed in Japanese Priority Patent Application JP 2024-179639 filed in the Japan Patent Office on Oct. 15, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A touch panel comprising:
a touch sensor configured to form an electrostatic capacitance with a pointing object; and
a control circuit, wherein
the control circuit is configured to
based on a signal from the touch sensor, determine whether or not a filter is provided between the touch sensor and the pointing object,
upon determining that the filter is not provided between the touch sensor and the pointing object, amplify a signal from the touch sensor at a first amplification factor to generate a first amplified signal, and, based on the first amplified signal, determine whether or not there is a touch on the touch sensor with the pointing object, and
upon determining that the filter is provided between the touch sensor and the pointing object, amplify a signal from the touch sensor at a second amplification factor to generate a second amplified signal, the second amplification factor being greater than the first amplification factor, and, based on the second amplified signal, determine whether or not there is a touch on the touch sensor with the pointing object.

2. The touch panel according to claim 1, wherein
the control circuit is configured to
amplify a signal from the touch sensor at a third amplification factor to generate a third amplified signal,
determine that the filter is provided between the touch sensor and the pointing object when the third amplified signal is not less than a first threshold but not greater than a second threshold, the first threshold being a threshold for touch detection, the second threshold being greater than the first threshold, and
determine that the filter is not provided between the touch sensor and the pointing object when the third amplified signal is greater than the second threshold.

3. The touch panel according to claim 2, wherein
the control circuit is configured to
determine that the filter is provided between the touch sensor and the pointing object when the third amplified signal that is not less than the first threshold but not greater than the second threshold is acquired consecutively a predetermined plurality of number of times, and
determine that the filter is not provided between the touch sensor and the pointing object when the third amplified signal that is not less than the first threshold but not greater than the second threshold is not acquired consecutively the predetermined plurality of number of times.

4. The touch panel according to claim 1, wherein
the control circuit is configured to, upon determining that the filter is provided between the touch sensor and the pointing object, determine the second amplification factor such that, the greater a value of a difference between a signal from the touch sensor and a reference value is, the greater a determined value of the second amplification factor is.

5. The touch panel according to claim 2, wherein
the control circuit is configured to, when the second amplified signal has become greater than a third threshold after determining that the filter is provided between the touch sensor and the pointing object, the third threshold being greater than the second threshold, determine that the filter provided between the touch sensor and the pointing object has been removed.

6. The touch panel according to claim 1, wherein
the control circuit is configured to
amplify a signal from the touch sensor at a fourth amplification factor to generate a fourth amplified signal, the fourth amplification factor being greater than the first amplification factor,
determine that the filter has been removed when the fourth amplified signal has become greater than a fourth threshold, and
determine that the filter is provided when the fourth amplified signal is not greater than the fourth threshold.

7. The touch panel according to claim 1, wherein
the control circuit is configured to
initiate a calibration mode in response to a user operation, and
based on a signal acquired from the touch sensor during an execution of the calibration mode, calibrate the second amplification factor.

8. The touch panel according to claim 7, wherein
the control circuit is configured to, based on a signal, from the touch sensor, outputted when each of a plurality of positions spaced from one another on the touch sensor is touched with the pointing object during the execution of the calibration mode, calibrate the second amplification factor.

9. A display device comprising:
the touch panel according to claim 1; and
a display layered on the touch panel.

10. A method of controlling a touch panel, comprising:
determining, based on a signal from a touch sensor, whether or not a filter is provided between the touch sensor and a pointing object, the touch sensor being configured to form an electrostatic capacitance with the pointing object;
upon determining that the filter is not provided between the touch sensor and the pointing object, amplifying a signal from the touch sensor at a first amplification factor to generate a first amplified signal, and, based on the first amplified signal, determining whether or not there is a touch on the touch sensor with the pointing object; and
upon determining that the filter is provided between the touch sensor and the pointing object, amplifying a signal from the touch sensor at a second amplification factor to generate a second amplified signal, the second amplification factor being greater than the first amplification factor, and, based on the second amplified signal, determining whether or not there is a touch on the touch sensor with the pointing object.
